(19) United States
(12) Patent Application Publication
(10) Pub. No.: US 2019/0190821 A1
(43) Pub. Date: Jun. 20, 2019

(54) METHOD OF OPTIMIZING SPECTRAL EFFICIENCY IN AN MPLS INTERCONNECTION CONTEXT

(71) Applicant: THALES, Courbevoie (FR)

(72) Inventors: Nicolas VAN WAMBEKE, Toulouse (FR); Pierre ROGNANT, Toulouse (FR)

(21) Appl. No.: 16/222,989

(22) Filed: Dec. 17, 2018

(30) Foreign Application Priority Data
Dec. 19, 2017 (FR) 1701325

(51) Int. Cl. H04L 12/723; H04L 12/46; H04B 7/185

(52) U.S. Cl. CPC H04L 45/50; H04L 69/22; H04B 7/18513; H04L 12/4633

(57) ABSTRACT

A method is provided for transmitting data between a first communication device and a second communication device, the first communication device being configured to receive from a router connected to the first communication device data in the form of packets comprising at least one intermediate level label, wherein the method comprises at least: a) an initial step of connection setup, comprising at least: a1) a sub-step of transmitting the intermediate level label; a2) a sub-step of recording the intermediate level label; b) a step of transmitting the data packet, comprising: b1) a sub-step of deleting the intermediate level label transmitted by the router connected to the first communication device in the data packet; b2) A sub-step of transmitting the de-encapsulated data packet, with a view to being reconstructed after its transmission.

### CROSS-REFERENCE TO RELATED APPLICATIONS

This application claims priority to foreign French patent application No. FR 1701325, filed on Dec. 19, 2017, the disclosure of which is incorporated by reference in its entirety.

### FIELD OF THE INVENTION

The invention lies in the field of systems for satellite communication between two communication devices, notably between a gateway and a terminal. The terminal may be embedded on board a vehicle, notably an aircraft, in particular a drone. The invention is situated in a context of optimization of the use of the bandwidth on the radio linkup between two communication devices, in a context of MPLS interconnection with other networks.

### BACKGROUND

One of the main constraints in current satellite communication systems resides in the fact that the radiocommunications resources are very limited, with data streams, notably multimedia streams, exhibiting significant demands in terms of constancy of the bitrate offered but also in terms of lag in forwarding the information across the communication system. These communications exhibit heavy constraints in respect of integrity and forwarding guarantees. The recommendations of the European program SESAR (or Single European Sky ATM Research, for Single European Sky Air Traffic Management Research) and the tendencies of commercial operators advocate the use of the MPLS (Multi Protocol Label Switching) protocol suite up to and within the terminal for the setup of the data links, notably to avoid having a particular routing protocol on each router.

The MPLS protocol suite is a solution to the interface of level 2 (data link layer) and of level 3 (network layer) of the OSI model. It thus relies on the principle of switching of intermediate level labels between the level 2 header and the level 3 header of the OSI model. The MPLS protocol suite consists in performing a switching, namely a forwarding of data packets on the basis of a previously set up path, consisting of a list of labels. FIG. 1 illustrates the operating principle of this protocol suite, within the framework of a communication between two computing units PC1 and PC2. The computing unit PC1, belonging to the network RES1, dispatches a data packet to the router ROUT1. The choice of the path between the source and the destination is performed by the first MPLS router, also called “ingress Label Switch Router” in the art (or “ingress LSR”, LSR-A in FIG. 1). This path is called a “tunnel”, and the first MPLS router adds at least one header, called an MPLS label, to the data packet; the latter is placed between the level 2 header and the level 3 header, according to a so-called encapsulation procedure. The level 3 header is thus “masked” by the MPLS label, so as to favour the switching and the static correspondence of the labels. On receipt of a data packet, each given router supporting the MPLS protocol suite (also called “Label Switch Router” in the art, or LSR, LSR-B in FIG. 1) searches, in a base LFIB (for Label Forwarding Information Base), to find which router is the next to which to transmit the data packet. For reasons of flexibility, traffic engineering or else redundancy, it is possible to stack MPLS labels. Exit from the tunnel is performed through the last MPLS router of the path, also called the “egress Label Switch Router” in the art (or “egress LSR”, LSR-D in FIG. 1), which removes the packet's MPLS header, according to a so-called de-encapsulation procedure, so that the IP routing can again be applied so as to reach the recipient, namely the router ROUT2 of the network RES2 and then the computing unit PC2. Only the first MPLS router (“ingress LSR”) and the last MPLS router (“egress LSR”) carry out a search in their switching table, the other MPLS routers (“LSR”) using only the MPLS labels with the aid of their MPLS labels replacement table.

The use of the MPLS protocol suite thus adds switching labels to each data packet. In a context of use of the MPLS protocol suite in a satellite communication system, in the downlink, the satellite's coverage zone may comprise a plurality of gateways which receive the data packets transmitted by the satellite. Each gateway in the satellite's coverage zone thus receives the switching labels in each data packet, whilst the switching labels are useful only for a gateway. Moreover, in the uplink, the gateway pointing towards the satellite transmits to a terminal by way of the satellite the data packet comprising the switching labels, but also transmits these data packets to the other gateways which are in its radiation zone. In all cases, the air interface, and more generally the various resources of the system, are greatly affected by the extra bitrate engendered by the transmission of the switching labels, thereby correspondingly reducing the communication system's performance.

A known solution for solving this problem can consist in putting in place mechanisms for compressing the protocol headers, such as the RoHC (Robust Header Compression) mechanism, standardized by the IETF organization under the reference RFC3095. This mechanism makes it possible to decrease the size of the header but exhibits other drawbacks. It requires an initial phase of prior handshaking of the hosts for each session of exchanges, and is complex to implement. Moreover, it generates, in this initial handshaking phase, a significant quantity of data, thus running counter to the initial objective of optimizing the spectral efficiency. It is thus notably not suitable for communications of small messages (a few bytes or tens of bytes), transmitted for example during TCP connections.

In the MPLS protocol suite, it is also known to use a technique termed “penultimate hop popping”, which consists, at the level of the MPLS router situated just before the last router (“egress LSR”) of the tunnel, in deleting the MPLS label and replacing it with the “implicit-null” output label. This technique allows the last router (“egress LSR”) not to have to perform at one and the same time a search in the base LFIB, and a search in their routing table. However, this solution can only be implemented at the transmission end, and makes it possible to delete only a single MPLS label.

### SUMMARY OF THE INVENTION

An object of the invention is therefore to provide a method making it possible to efficiently optimize the spectral resources of a satellite communication between two communication devices, notably between a gateway and a terminal, in a context of MPLS interconnection with other networks, notably when the data packets to be communicated comprise several MPLS labels.

A subject of the invention making it possible to achieve this aim, partially or totally, is a method for transmitting data between a first communication device and a second communication device, the first communication device being configured to receive from a router connected to the first communication device data in the form of packets comprising at least one intermediate level label, characterized in that the method comprises at least:

a) an initial step of connection setup, comprising at least:
a1) a sub-step of transmission, by the first communication device to the second communication device, of the intermediate level label;
a2) a sub-step of recording, by the first communication device, of the intermediate level label;
b) a step of transmitting the data packet, comprising:
b1) a sub-step of deletion, by the first communication device, of the intermediate level label transmitted by the router connected to the first communication device in the data packet, to form a de-encapsulated data packet;
b2) a sub-step of transmission, by the first communication device to the second communication device, of the de-encapsulated data packet, with a view to being reconstructed after its transmission in the form of a reconstructed data packet comprising the de-encapsulated data packet and the recorded intermediate level label.

Advantageously, the step of transmitting the data packet also comprises:
b3) a sub-step of comparison, by the first communication device, of the intermediate level label received from the router connected to the first communication device with the intermediate level label recorded in the first communication device;
b4) in case of difference between the intermediate level label received from the router connected to the first communication device and the intermediate level label recorded in the first communication device, a sub-step of addition by the first communication device of a signalling header in the de-encapsulated data packet to be transmitted to the second communication device, and a sub-step of updating the intermediate level label recorded on the basis of the data contained in the signalling header.

Advantageously, the signalling header comprises the intermediate level label to be updated.

Advantageously, the intermediate level label is an MPLS label, the router connected to the first communication device (LSR-EC1) is an MPLS label switching router.

Advantageously, the first communication device is configured to communicate with the second communication device on a satellite link interface.

Advantageously, the first communication device is a gateway, the second communication device is a terminal.

As a variant, the first communication device is a terminal, the second communication device is a gateway.

Another subject of the invention is a method of reception, by a second communication device, of data sent by a first communication device, the second communication device being configured to transmit to a router connected to the second communication device data in the form of packets comprising at least one intermediate level label, characterized in that the method comprises at least:

A. an initial step of connection setup, comprising at least:
A1) a sub-step of reception, by the second communication device, of the intermediate level label transmitted by the first communication device;
A2) a sub-step of recording, by the second communication device, of the intermediate level label;

B. a step of receiving the data packet, comprising:
B1) a sub-step of reception, by the second communication device, of a de-encapsulated data packet not comprising any intermediate level label;
B2) a sub-step of reconstruction, by the second communication device, of a reconstructed data packet composed of the de-encapsulated data packet and of the previously recorded intermediate level label.

Advantageously, the step of receiving the data packet also comprises:
B3) a sub-step of updating the recorded intermediate level label in case of reception of a signalling header with the de-encapsulated data packet, on the basis of the data contained in the signalling header.

Advantageously, the signalling header comprises the intermediate level label to be updated.

Advantageously, the intermediate level label is an MPLS label, the router connected to the second communication device is an MPLS label switching router.

Advantageously, the second communication device is configured to communicate with the first communication device on a satellite link interface.

Advantageously, the first communication device is a gateway, the second communication device is a terminal.

As a variant, the first communication device is a terminal, the second communication device is a gateway.

Another subject of the invention is a computer program product comprising instructions for the execution of the method of transmission according to one of the claims aforementioned or of the aforementioned method of reception when the program is executed by a processor.

Another subject of the invention is a communication device configured to receive from a router connected to the said device data in the form of packets comprising at least one intermediate level label, and to transmit them on a satellite link interface, the communication device furthermore being configured to execute the aforementioned method of transmission.

Another subject of the invention is a communication device configured to receive data in the form of packets comprising at least one intermediate level label, and to transmit them to a router connected to the said device, the said device furthermore being configured to execute the aforementioned method of reception.

Another subject of the invention is an aircraft comprising an aforementioned communication device.

### BRIEF DESCRIPTION OF THE DRAWINGS

Other characteristics, details and advantages of the invention will emerge on reading the description given with reference to the appended drawings which are given by way of example and represent, respectively:

FIG. 1, a diagram illustrating the operating principle of the MPLS protocol suite;

FIG. 2, a schematic of systems for communication on a satellite link interface;

FIG. 3, a diagram illustrating the processing of a data packet between the various entities of a network, according to a prior art transmission scheme;

FIG. 4, a diagram illustrating the processing of a data packet between the various entities of a network, according to a transmission scheme complying with the invention;

FIG. 5, a flowchart illustrating the method of data transmission according to the invention;

FIG. 6, a flowchart illustrating the method of data reception according to the invention.

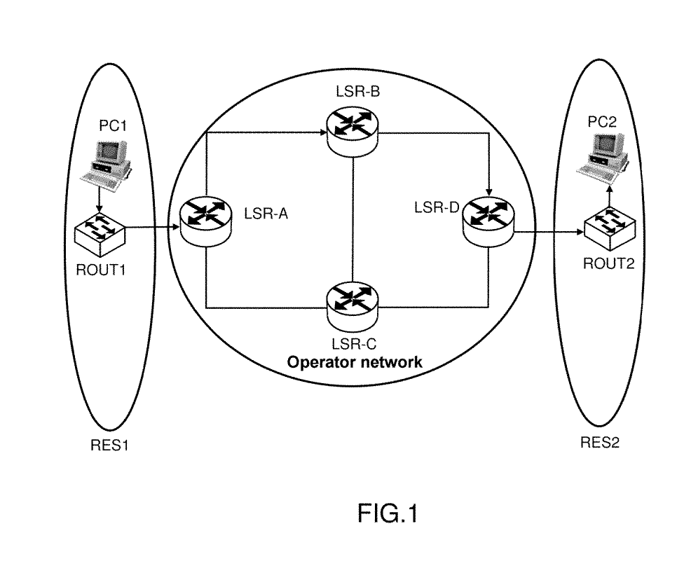

### DETAILED DESCRIPTION

By “terminal” is meant a communicating device, which may be fixed (for example on the roof of a building) or mobile (for example on a mobile carrier, notably a piloted aircraft or a drone).

By “gateway” is meant the subset of a ground station which communicates on one side with a satellite, and on the other side with a local network.

By “MPLS interconnection context” is meant the possibility of making a communication device, notably a gateway or a terminal, dialogue with MPLS routers.

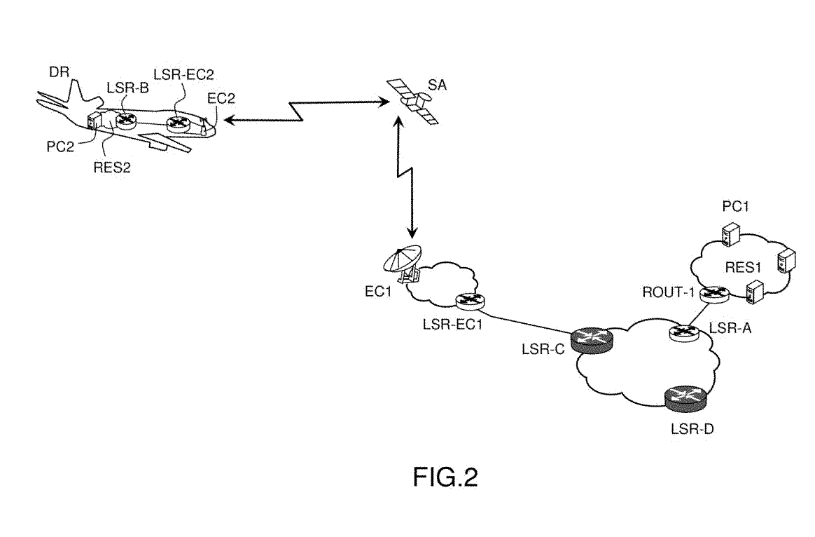

FIG. 2 schematically illustrates a system for communication on a satellite link interface. The system consists of a user segment, of a ground segment and of a space segment. The user segment comprises notably a communication device EC2 which may be a terminal. The terminal receives the multimedia services to which it has subscribed, and can transmit data via a return voice which may be terrestrial or by satellite. The terminal moreover comprises a means of interconnection with a network, optionally via an LSR-MPLS router in an MPLS interconnection context. The ground segment comprises the entities responsible for the control of the network and the management of the satellite. It also comprises the entities responsible for the interconnection with exterior networks, notably communication devices EC1 of gateway type. A gateway comprises notably the antenna and the device required to convert the RF signal, on the satellite link interface, into an IP signal for terrestrial connectivity, and vice versa. The space segment comprises the satellites able to communicate with the ground segment and with the user segment. The space segment comprises a constellation of satellites SA which ensure the relay, the amplification and the transposition of the transmitted signal. The first communication device EC1 may be linked to an MPLS router (LSR-EC1). In the same way, the second communication device EC2 may be linked to an MPLS router (LSR-EC2). Several MPLS routers are also represented in FIG. 2. FIG. 2 therefore represents schematically a “tunnel” used in the MPLS protocol suite, namely the switching of data packets between a source (the unit PC1) and a recipient (the unit PC2), via a first router ROUT-1 of the network RES1, a router of “ingress LSR” type (LSR-A), a plurality of MPLS routers (LSR-C, LSR-D,) and a router of “egress LSR” type (LSR-B). The present invention is described and illustrated for a data transmission from the first communication device EC1 to the second communication device EC2, in the case where the first communication device EC1 is a gateway, and where the second communication device EC2 is a terminal (outbound direction); it applies in the same way to a data transmission in the case where the first communication device EC1 is a terminal, and where the second communication device EC2 is a gateway (return direction). Other configurations of routers may be envisaged, without departing from the scope of the invention.

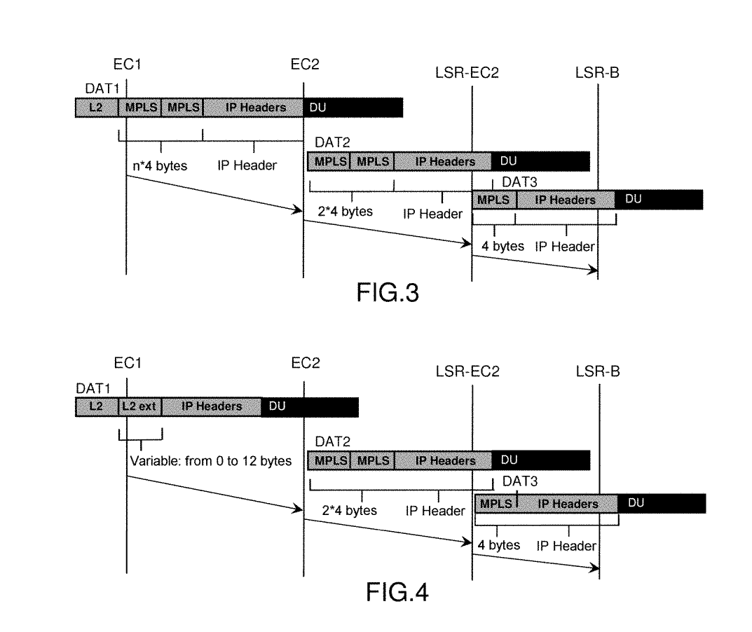

FIG. 3 illustrates a processing diagram in respect of a data packet DAT1 sent by the first communication device EC1, according to a transmission scheme of the prior art. A header L2 followed by at least one intermediate level label (MPLS label) and by an IP header (IPv4 or IPv6) preceding the data to be transmitted, also called useful data DU. The header L2 generally comprises information required for the management of the logic linkup which is set up between the first communication device EC1 and the second communication device EC2, such as for example the source and destination addresses, the size of the data included in the frame, the optional indication of fragmentation, the traffic class to which the data belong. Each MPLS label comprises 4 bytes, and several MPLS labels can be stacked. The header L2 of the packet DAT1 is removed by the second communication device EC2, to form the packet DAT2. The packet DAT2 is transmitted to the router LSR-EC2, operating according to the MPLS protocol suite. The router LSR-EC2 forms a packet DAT3, destined for the router LSR-B which may be situated aboard the carrier DR. The processing diagram in respect of a datagram sent by a second communication device EC2, of the user segment, to a first communication device EC1, of the ground segment, is identical.

The data contained in the intermediate level label are always the same from one data packet to the next. Indeed, the main fields of the intermediate level label have as value the identifiers of the labels active on the link between the first communication device EC1 and the second communication device EC2. Thus, the invention rests upon deletion of the redundant data sent on the satellite link interface, in particular with a view to interconnection with MPLS routers, for which the information in respect of MPLS labels must be preserved between the “ingress LSR” and the “egress LSR”.

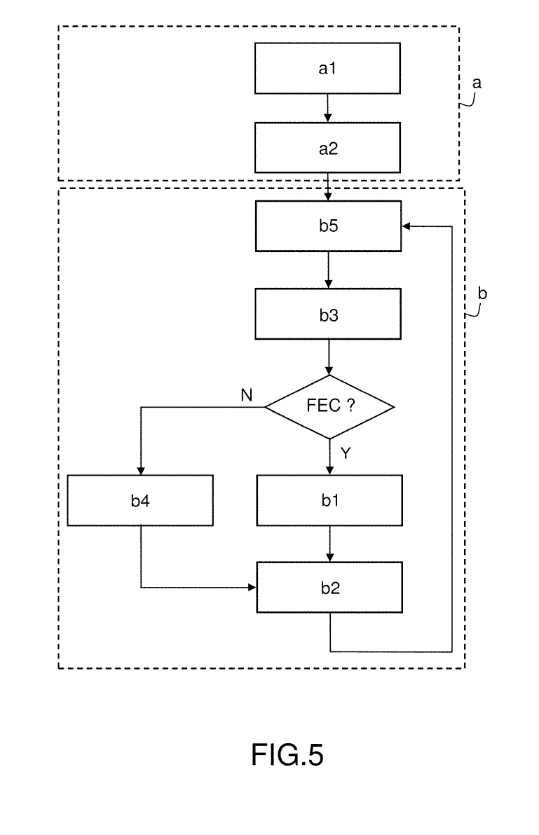

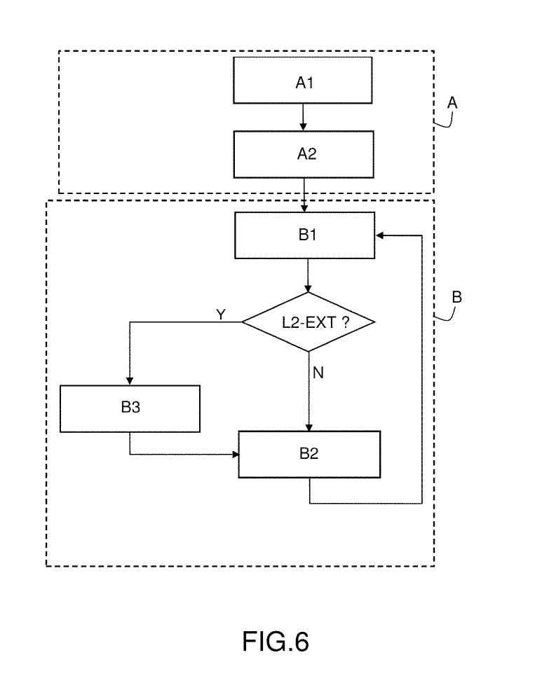

The invention rests therefore upon the exchange of information during setup of the connection between the first communication device EC1 and the second communication device EC2. This information exchange during setup of the connection is represented in FIG. 5 by step a) on the side of the first communication device EC1, and in FIG. 6 by step A) on the side of the second communication device EC2. During setup of the connection, the first communication device EC1 records in its system tables the various elements required for putting in place the MPLS protocol suite, notably the MPLS labels, the service class, the TTL of the packet (Time to Live). The first communication device EC1 transmits to the second communication device EC2 a unique identifier specific to the first communication device EC1, so that the second communication device EC2 can identify it during the transmission step. The second communication device EC2 which seeks to set up a link at the level of the data link layer (layer 2 of the OSI model) uses the information that it receives from the system tables of the first communication device EC1 to determine the network layer configuration parameters (autoconfiguration of the addresses, definition of the default route). The first communication device EC1 thus transmits to the second communication device EC2 the intermediate level labels (MPLS labels) that it has received from the router LSR-EC1 (sub-step a1), by way of the message requesting connection to the system. During a so-called recording sub-step, represented at the sending end in FIG. 5 by the reference a2, the first communication device EC1 and the second communication device EC2 record the set of intermediate level labels that have to be transmitted to the router LSR-TL. Thus, on completion of the connection setup step, the first communication device EC1 and the second communication device EC2 each have a local copy of the intermediate level labels.

Once the connection setup step is finished, the transfer of each data packet between the first communication device EC1 and the second communication device EC2 can take place; this step is represented as a whole in the diagram of FIG. 4. It is also represented in FIG. 5, at the sending end, by the reference b and in FIG. 6, at the receiving end, by the reference B. The first communication device EC1, on receipt of each data packet (step b5), determines firstly whether the latter is destined for one of the second communication devices EC2 connected to the system. In the affirmative, the first communication device EC1 compares, in a sub-step b3), the intermediate level labels present in the data packet with the intermediate level labels recorded in the first communication device EC1. In the converse case, the data packet is ignored and deleted.

If the labels are identical (one speaks of FEC for “Forward Equivalence Class”, or transfer equivalence class), the first communication device EC1 entirely deletes the intermediate level labels potentially present in the data packet, namely the MPLS labels in the case of an interconnection with MPLS routers (sub-step b1 in FIG. 5). The first communication device EC1, in a sub-step b2), transmits the packet to the second communication device EC2, while signalling the type “Headers removed”, so that the second communication device EC2 can distinguish the data packets with reduced header from the other packets.

If, on the contrary, the intermediate level labels present in the packet are different from the intermediate level labels recorded in the first communication device EC1, the first communication device EC1 then constructs a signalling header L2-ext containing the information required for the reconstruction by the terminal of the intermediate level labels by combination with the information at the disposal a priori of the second communication device EC2. The signalling header L2-ext may be of variable size, for example from 0 to 12 bytes. The maximum size of 12 bytes corresponds to three MPLS labels, each MPLS label making four bytes. The maximum size may, however, be configured to be different from twelve bytes. The number of bytes of the signalling header L2-ext is proportional to the significance of the change in the intermediate level label. The first communication device EC1 records the updated intermediate level label (step b4).

The method of reception, on the side of the second communication device EC2, illustrated by FIG. 6, comprises a first sub-step A1) of reception, by the second communication device EC2, of the intermediate level label transmitted by the first communication device EC1 and a second sub-step A2) of recording by the second communication device EC2, of the intermediate level label. The second communication device EC2 receives the de-encapsulated data packet (sub-step B1), and reconstructs the packet with the aid of the recorded intermediate level label (sub-step B2). It can thereafter transmit the reconstructed packet to the router LSR-EC2, and process a new data packet, for which step B is applied again. If the de-encapsulated data packet received by the second communication device EC2 is preceded by a signalling header L2-ext, it updates its tables, records the intermediate level labels (sub-step B3), and can reconstruct the packet with the recorded and updated intermediate level label.

The performance gain obtained with the method according to the invention is particularly noteworthy for small packets, of the order of a few tens of bytes. Thus, for data packets having a payload substantially equal to 80 bytes every 30 ms, as may be the case for the G.723.1 audio compression standard used in videoconferencing and telephony over IP, it has been possible to simulate a gain of 12% in volume on the satellite link interface between a gateway (first communication device) and a terminal (second communication device EC2). The spectral resources of a satellite communication in a context of MPLS interconnection with other networks are thus efficiently optimized.

The invention has been described and illustrated in particular for a data transmission in the case where the first communication device EC1 is a gateway and where the second communication device EC2 is a terminal. The transmission of data in the case where the first communication device EC1 is a terminal and where the second communication device EC2 is a gateway, operates in an analogous way.

1. A method for transmitting data between a first communication device and a second communication device, the first communication device being configured to receive from a router connected to the first communication device data in the form of packets comprising at least one intermediate level label, wherein the method comprises at least:
a) an initial step of connection setup, comprising at least:
a1) a sub-step of transmission, by the first communication device to the second communication device, of the intermediate level label;
a2) a sub-step of recording, by the first communication device, of the intermediate level label;
b) a step of transmitting the data packet, comprising:
b1) a sub-step of deletion, by the first communication device, of the intermediate level label transmitted by the router connected to the first communication device in the data packet, so as to form a de-encapsulated data packet;
b2) a sub-step of transmission, by the first communication device to the second communication device, of the de-encapsulated data packet, with a view to being reconstructed after its transmission in the form of a reconstructed data packet comprising the de-encapsulated data packet and the recorded intermediate level label;
b3) a sub-step of comparison, by the first communication device, of the intermediate level label received from the router connected to the first communication device with the intermediate level label recorded in the first communication device;
b4) in case of difference between the intermediate level label received from the router connected to the first communication device and the intermediate level label recorded in the first communication device, a sub-step of addition by the first communication device of a signalling header in the de-encapsulated data packet to be transmitted to the second communication device, and a sub-step of updating the intermediate level label recorded on the basis of the data contained in the signalling header.

2. The method of transmission according to claim 1, the signalling header comprising the intermediate level label to be updated.

3. The method of transmission according to claim 1, the intermediate level label being an MPLS label, the router connected to the first communication device being an MPLS label switching router.

4. The method of transmission according to claim 1, the first communication device being configured to communicate with the second communication device on a satellite link interface.

5. The method of transmission according to claim 1, the first communication device being a gateway, the second communication device being a terminal.

6. The method of transmission according to claim 1, the first communication device being a terminal, the second communication device being a gateway.

7. The method of reception, by a second communication device, of data sent by a first communication device, the second communication device being configured to transmit to a router connected to the second communication device data in the form of packets comprising at least one intermediate level label, wherein the method comprises at least:
A. an initial step of connection setup, comprising at least:
A1) a sub-step of reception, by the second communication device, of the intermediate level label transmitted by the first communication device;
A2) a sub-step of recording, by the second communication device, of the intermediate level label;
B. a step of receiving the data packet, comprising:
B1) a sub-step of reception, by the second communication device, of a de-encapsulated data packet not comprising any intermediate level label;
B2) a sub-step of reconstruction, by the second communication device, of a reconstructed data packet composed of the de-encapsulated data packet and of the previously recorded intermediate level label;
B3) a sub-step of updating the recorded intermediate level label in case of reception of a signalling header with the de-encapsulated data packet, on the basis of the data contained in the signalling header.

8. The method of reception according to claim 7, the signalling header comprising the intermediate level label to be updated.

9. The method according to one of claim 7, the intermediate level label being an MPLS label, the router connected to the second communication device being an MPLS label switching router.

10. The method of reception according to claim 7, the second communication device being configured to communicate with the first communication device on a satellite link interface.

11. The method of reception according to claim 7, the first communication device being a gateway, the second communication device being a terminal.

12. The method of reception according to claim 7, the first communication device being a terminal, the second communication device being a gateway.

13. A non-transitory computer readable medium having stored thereon a computer program comprising instructions for the execution of the method of transmission according to claim 1, when the program is executed by a processor.

14. A communication device configured to receive from a router connected to the said device data in the form of packets comprising at least one intermediate level label, and to transmit them on a satellite link interface, the communication device furthermore being configured to execute the method of transmission according to claim 1.

15. The communication device configured to receive data in the form of packets comprising at least one intermediate level label, and to transmit them to a router connected to the said device, the said device furthermore being configured to execute the method of reception according to claim 7.

16. The non-transitory computer readable medium having stored thereon a computer program comprising instructions for the execution of the method of transmission according to claim 7, when the program is executed by a processor.
